(19) United States
(12) Patent Application Publication
(10) Pub. No.: US 2024/0167519 A1
(43) Pub. Date: May 23, 2024

(54) FOLDABLE PTO SHAFT PROTECTION COVER

(71) Applicant: Daedong Corporation, Nongong-eup (KR)

(72) Inventor: Jin Mok PARK, Changnyeong-gun (KR)

(21) Appl. No.: 17/993,044

(22) Filed: Nov. 23, 2022

(51) Int. Cl. F16D 3/84; A01B 76/00; B60K 17/28

(52) U.S. Cl. CPC F16D 3/841; A01B 76/00; B60K 17/28

(57) ABSTRACT

The present disclosure relates to a foldable PTO shaft protection cover for protecting a PTO shaft installed at the rear of a tractor when connecting a working machine to the rear of a tractor to work and separating the working machine from the rear. A foldable PTO shaft protection cover for protecting a PTO shaft of a tractor from the outside includes: a rear cover covering the circumference of a PTO shaft; left and right covers installed at left and right sides of the rear cover and covering the PTO shaft at the left and right sides; a top cover mounted to be able to rotate 90 degrees up and down above and ahead of the left and right covers; and a bracket disposed over the left and right covers to be installed on a tractor body and supporting a top cover in an opened state or a closed state.

### BACKGROUND OF THE INVENTION

### Field of the Invention

The present disclosure relates to a foldable PTO shaft protection cover for protecting a PTO shaft installed at the rear of a tractor when connecting a working machine to the rear of a tractor to work and separating the working machine from the rear. In detail, the present disclosure relates to a foldable PTO shaft protection cover that covers the top, left, and right sides of a PTO shaft installed at the rear of a tractor when working with the PTO shaft and a universal joint of a working machine connected to each other, and that covers the top, left, right, and rear sides of a PTO shaft installed at the rear of a tractor when separating a universal joint of the working machine from the PTO shaft.

### Description of the Related Art

Since the PTO shaft of a tractor always rotates regardless of motion of the vehicle while working is performed, there is danger of a big accident when a person or an object around a vehicle comes in contact with the PTO shaft with the vehicle stopped. Further, a PTO shaft includes a universal joint, a gear, or the like to transmit rotation power and such universal joint or gear is always applied with a lubricant, etc. for smooth operation, so there is a problem that when soil or foreign substances stick to the PTO shaft during working in a rice field or a patch, power transmission is stopped or parts are damaged. Accordingly, a cover that prevents soil or dust from sticking to a PTO shaft by preventing a side or the circumference of a PTO shaft being exposed to outside is installed.

Meanwhile, as a prior art document related to a PTO shaft cover, Korean Patent No. 10-1417629 (registered on Jun. 30, 2014, hereafter, referred to as “patent document 1”) has disclosed a technology related to a PTO shaft protection cover for a tractor that includes: a side cover 120 that blocks access from the outside by covering both sides of a power take off (PTO) shaft 110 protruding outward from a tractor, has an opening 124 formed in the up-down direction over the PTO shaft 110, and has coupling grooves 121 at the upper ends of the end in the extension direction of the PTO shaft 110; and a top cover that is coupled at an end to a side of the top of the side cover 120 by a hinge bolt 140 to open/close the opening 124 by rotating about the hinge bolt 140, has bends 132 at the ends of both left and right sides such that both sides of the side cover 120 can be inserted therein, and has coupling protrusions 131 formed on the inner sides facing the center of the bends 132 to be able to be fixed in the coupling grooves 121.

Further, Japanese Patent Application Publication No. 09-109710 (published on Apr. 28, 1997, hereafter, referred to as “patent document 2”) has disclosed a technology that provides a pin protruding inside a machine at the end of a pair of left and right cylinder pin in the machine and supports a PTO cover covering the top of a PTO shaft to be able to rotate upward in an agricultural tractor in which a pair of left and right lift arms is supported on the top of the rear of a mission case having the PTO shaft protruding rearward from the machine, a hydraulic cylinder, which moves up and down the lift arms, is disposed outside to be partially inserted in a base of left and right axle cases protruding rearward further than the mission case, and the hydraulic cylinder is held on brackets disposed on the rear surfaces of the axle cases and the mission case such that a lower attachment portion thereof is supported by the cylinder pins.

Further, Japanese Patent Application Publication No. 2013-247904 (published on Dec. 12, 2013, hereafter, referred to as “patent document 3”) has disclosed a technology about a PTO shaft cover for an agricultural tractor in which, in order to prevent dirt from entering into a space between the rear side of a mission case and the front side of the PTO cover by enabling the cover to be easily opened/closed, a PTO shaft is installed to protrude rearward from the rear of the mission case, the upper portion of the front side of the PTO cover is supported to be movable up and down on left and right brackets, which are installed at the left and right sides of the PTO shaft, by a lateral shaft behind the mission case, and a closing plate is connected to the front side of the upper portion of the PTO cover to close the space between the rear surface of the mission case and the front side of the PTO cover.

### CITATION LIST

### Patent Literature

(Patent Document 1) Patent Document 2: Korean Patent No. 10-1417629 (registered on 2014 Jun. 30)
(Patent Document 2) Patent Document 3: Japanese Patent Application Publication 09-109710 (published on 1997 Apr. 28)
(Patent Document 3) Patent Document 4: Japanese Patent Application Publication 2013-247904 (published on 2013 Dec. 12)

### SUMMARY OF THE INVENTION

In the related art, when a working machine is coupled to a tractor, work is performed with a PTO shaft installed at the rear of the tractor and a universal joint of the working machine connected to each other, and in this case, users often separate a PTO shaft protection cover installed at the rear of the tractor for easy work. Further, when a PTO shaft protection cover is separated, the PTO shaft protection cover is separately stowed even after a working machine is separated, which causes damage to a PTO shaft.

An objective of the present disclosure is to protect a PTO shaft installed at the rear of a tractor when connecting a working machine to the rear of a tractor to work and separating the working machine from the rear.

Further, another objective of the present disclosure is to manufacture a PTO shaft protection cover in a simple structure and to enable a user to easily open/close the PTO shaft protection cover through simple operation.

In order to achieve the objectives of the present disclosure, a foldable PTO shaft protection cover for protecting a PTO shaft of a tractor from the outside includes: a rear cover 100 covering the circumference of a PTO shaft S; left and right covers 200 and 300 installed at left and right sides of the rear cover and covering the PTO shaft at the left and right sides; a top cover 400 mounted to be able to rotate 90 degrees up and down above and ahead of the left and right covers 200 and 300; and a bracket 500 disposed over the left and right covers 200 and 300 to be installed on a tractor body and supporting a top cover 400 in an opened state or a closed state.

In the foldable PTO shaft protection cover, the top cover 400 includes a top surface cover 410, a top left cover 420, and a top right cover 430, the top surface cover 410 is formed in an L-shape, top cover support hinges 440 are formed at an end of the top surface cover 410, a top cover locking protrusions 450 are formed at edges of the top surface cover 410, and the top cover hinges 440 are inserted in support hinge holes 240 and 340 formed at upper front edges of the left and right covers 200.

In the foldable PTO shaft protection cover, the locking protrusion support grooves 220 and 320 locking the top cover locking protrusions 450 to maintain the top cover 100 in the closed state are installed at upper portions close to a working machine of the left and right covers 200 and 300.

In the foldable PTO shaft protection cover, the bracket 500 has left and right cover support brackets 510 formed at upper portions close to a tractor body of the left and right covers 200 and 300, and top cover locking clamps 520 supported by the left and right cover support brackets 510 and locking the upper cover locking protrusions 450 to maintain the top cover in the opened state.

### BRIEF DESCRIPTION OF THE DRAWINGS

FIG. 1 is a view showing a PTO shaft protection cover with a universal joint coupled to a PTO shaft in the related art;

FIG. 2 is a view showing the PTO shaft protection cover for covering a PTO shaft with the universal joint separated from a PTO shaft in the related art;

FIG. 3 is a view showing an opened state and a closed state of a PTO shaft protection cover of the present disclosure; and

FIG. 4 is a view showing a PTO shaft protection cover with a universal joint coupled to a PTO shaft in the present disclosure.

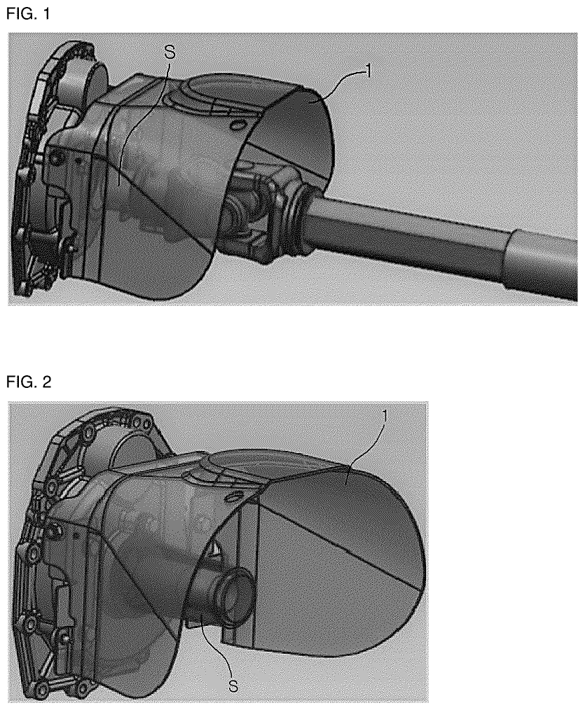

### DETAILED DESCRIPTION OF THE PREFERRED EMBODIMENTS

Terminologies that are generally used at present were selected and used in the present disclosure, but some specific terminologies were freely selected by the applicant(s), and in this case, the meanings of the specific terminologies should be construed not in consideration of simply the names of the terminologies, but in consideration of the meanings that are described or used in the detailed description of the present disclosure.

The technical configuration of the present disclosure will be described hereafter in detail with reference to preferred embodiments shown in the accompanying drawings.

A foldable PTO shaft protection cover of the present disclosure includes: a rear cover 100 covering the circumference of a PTO shaft; left and right covers 200 and 300 installed at left and right sides of the rear cover 100 and covering the PTO shaft at the left and right sides; a top cover 400 mounted to be able to rotate 90 degrees up and down above and ahead of the left and right covers 200 and 300; and a bracket 500 disposed over the left and right covers 200 and 300 to be installed on a tractor body and supporting a top cover 400 in an opened state or a closed state. These components are described hereafter in detail with reference to the figures.

[Rear Cover 100]

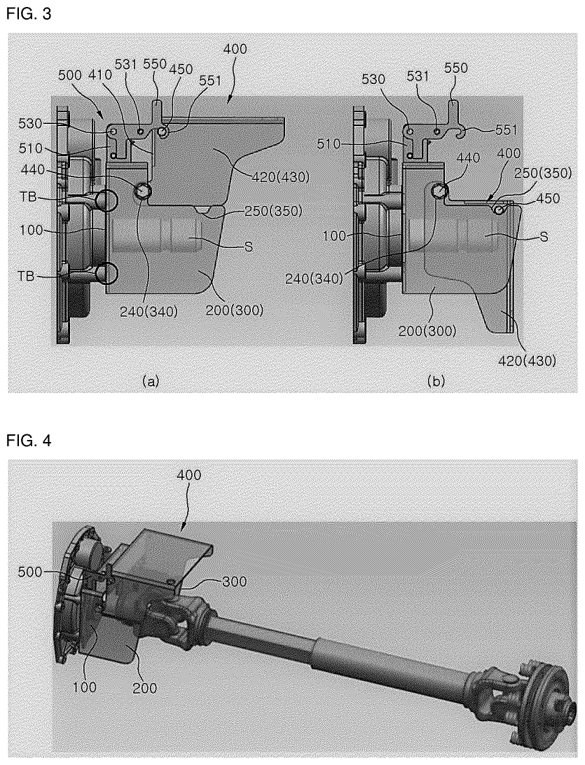

The rear cover 100 of the present disclosure, which is to be fixed to a tractor, as shown in FIGS. 3 and 4, is formed around a PTO shaft S.

Further, the rear cover 100 is not limited to a specific shape, but it is preferable that the PTO shaft can be positioned through the center thereof and the left and right covers 200 and 300 to be described below can be installed at the left and right sides thereof.

Further, the rear cover 100 may be integrally formed with the left and right covers 200 and 300.

It is preferable that the rear cover 100, as shown in FIG. 3, is fixed to a tractor 1 by a tractor fixing bolt TB, etc.

[Left and Right Covers 200, 300]

The left and right covers 200 and 300 of the present disclosure, which are installed at the left and right sides of the rear cover 100, as shown in FIGS. 3 and 4, may be installed to be detachable from the rear cover 100, though not shown in the figures. As shown in FIGS. 3 and 4, preferably, the left and right covers 200 and 300 are integrally formed with the rear cover 100, whereby they may be fixed to a tractor by fixing the rear cover 100 to the tractor by a tractor fixing bolt TB, etc.

Further, since the left and right covers 200 and 300 are installed only at the left and right sides, they do not cover upper and lower portions and a working machine.

Further, support hinge holes 240 and 340 are formed at the upper portions close to a tractor of the left and right covers 200 and 300, as shown in FIGS. 3 and 4, in order that top cover support hinges 440 of the top cover 400 to be described below can be inserted therein.

As described above, since the top cover support hinges 440 are inserted in the support hinge holes 240 and 340, the top cover 400 is coupled to be able to rotate 90 degrees up and down with respect to the left and right covers 200 and 300 fixed to the rear cover 100 which is to be fixed to the tractor 1 or integrally formed with the rear cover 100.

By the coupling described above, when the top cover 400 is rotated upward, the PTO shaft S is maintained in an opened state when seen from a working machine, and when the top cover 400 is rotated downward, the PTO shaft S is maintained in a closed state when seen from a working machine. FIGS. 3A and 4 show that the PTO shaft S is maintained in an opened state when seen from a working machine, and FIG. 3B shows that the PTO shaft S is maintained in a closed state when seen from a working machine.

Further, locking protrusion support grooves 250 and 350 are formed at the upper portion close to a working machine of the left and right cover 200 and 300 so that top cover locking protrusions 450 of the top cover 400 to be described below can be locked and supported therein.

As described, since the top cover locking protrusions 450 of the top cover 400 are locked and supported in the locking protrusion support grooves 250 and 350, the PTO shaft can be fully covered by the top cover 400.

[Top Cover 400]

The top cover support hinges 440 are installed through the top cover 400 of the present disclosure, as shown in FIGS. 3 and 4, so the top cover 400 is rotatably supported by the support hinge holes 240 and 340 over the left and right covers 200 and 300.

The top cover 400 is composed of a top surface cover 410, a top left cover 420, a top right cover 430, the top cover support hinges 440, and the top cover locking protrusions 450.

As shown in FIGS. 3 and 4, it is preferable that the top surface cover 410, the top left cover 420, and the top right cover 430 are integrally formed, the top surface cover 410 is formed in an L-shape, and the top left cover 420 and the top right cover 430 are made flat.

Further, the top cover locking protrusions 450 are locked and supported in locking hooks 551 of top cover locking clamps 550 or in the locking protrusion support grooves 250 and 350.

[Bracket 500]

The bracket 500 of the present disclosure, as shown in FIGS. 3 and 4, is fixed to the upper portions close to the tractor 1 of the left and right covers 200 and 300 to maintain the top cover 400 in the opened state with respect to the PTO shaft.

The bracket 500 has left and right cover support brackets 510 fixed to the left and right covers 200 and 300, and top cover locking clamps 550 hinged to the left and right covers 200 and 300 by clamp hinges 530 and locking and supporting the top cover locking protrusions 450 of the top cover 400 to support the top cover 400 in the opened state.

Further, locking hooks 551 may be further installed at the top cover locking clamps 550 to lock and support the top cover locking protrusions 450 of the top cover 400.

Further, a spring coupler 531 is installed on sides of the top cover locking clamps 550 so that springs (not shown) are supported by the left and right cover brackets 510 and the spring couplers 531. As described above, since springs are supported at the spring couplers 531, a worker can easily rotate the top cover locking clamps 550 upwardly with respect to the clamp hinges 530, so the top cover locking protrusions 450 of the top cover 400 can be easily supported or released by the locking hooks 551.

The above description is provided as an example of the present disclosure and the embodiments described herein are provided to describe the present disclosure rather than limiting the spirit of the present disclosure, so the present disclosure may be changed and modified in various ways by those skilled in the art without departing from the scope of the present disclosure.

Therefore, the protective scope of the present disclosure should be construed by those described in claims and technical configuration in the equivalent range should also be construed as being included in the scope of the present disclosure. For example, the top cover 400 is exemplified as an L-shaped cover member in the present disclosure, but the present disclosure should be construed as including an example that the top cover 400 is formed in a U-shape or an O-shape with one open side to cover a PTO shaft to completely cover a PTO shaft including even the bottom of the PTO shaft.

According to the present disclosure, it is possible to protect a PTO shaft installed at the rear of a tractor when connecting a working machine to the rear of a tractor to work and separating the working machine from the rear.

Further, according to the present disclosure, it is possible to manufacture a PTO shaft protection cover in a simple structure and to enable a user to easily open/close the PTO shaft protection cover through simple operation.

While the present invention has been described with respect to the specific embodiments, it will be apparent to those skilled in the art that various changes and modifications may be made without departing from the spirit and scope of the invention as defined in the following claims.

What is claimed is:

1. A foldable PTO shaft protection cover for protecting a PTO shaft of a tractor from the outside, the foldable PTO shaft protection cover comprising:
a rear cover covering the circumference of a PTO shaft;
left and right covers installed at left and right sides of the rear cover and covering the PTO shaft at the left and right sides;
a top cover mounted to be able to rotate 90 degrees up and down above and ahead of the left and right covers; and
a bracket disposed over the left and right covers to be installed on a tractor body and supporting a top cover in an opened state or a closed state.

2. The foldable PTO shaft protection cover of claim 1,
wherein the top cover includes a top surface cover, a top left cover, and a top right cover,
the top surface cover is formed in an L-shape,
top cover support hinges are formed at an end of the top surface cover,
a top cover support locking protrusions are formed at edges of the top surface cover, and
the top cover hinges are inserted in support hinge holes formed at upper front edges of the left and right covers.

3. The foldable PTO shaft protection cover of claim 2,
wherein locking protrusion support grooves locking the top cover locking protrusions to maintain the top cover in the closed state are installed at upper portions close to a working machine of the left and right covers.

4. The foldable PTO shaft protection cover of claim 2,
wherein the bracket has left and right cover support brackets formed at upper portions close to a tractor body of the left and right covers, and top cover locking clamps supported by the left and right cover support brackets and locking the upper cover locking protrusions to maintain the top cover in the opened state.
